(19) United States
(12) Patent Application Publication
(10) Pub. No.: US 2009/0059088 A1
(43) Pub. Date: Mar. 5, 2009

(54) BROADCAST RECEIVING APPARATUS AND PROGRAM REFERENCE CHART DISPLAYING METHOD

(75) Inventor: Hiroyuki Nakano, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/183,985

(22) Filed: Jul. 31, 2008

(30) Foreign Application Priority Data
Aug. 30, 2007 (JP) 2007-224386

(51) Int. Cl. H04N 5/50

(52) U.S. Cl. 348/731

(57) ABSTRACT

According to one embodiment, a broadcast receiving apparatus includes: a tuner selecting and receiving a broadcast signal of digital broadcast; a recording control module making video data obtained by the tuner receiving the broadcast signal recorded in a recording medium; a video reproducing module reproducing a video signal by using the video data recorded in the recording medium; a video data selecting module selecting only identical apparatus video data obtained by the tuner of the identical apparatus receiving the broadcast signal, among the video data recorded in the recording medium; and a displaying control module making a program reference chart corresponding to the identical apparatus video data selected by the video data selecting module displayed.

### CROSS-REFERENCE TO RELATED APPLICATIONS

This application is based upon and claims the benefit of priority from Japanese Patent Application No. 2007-224386, filed Aug. 30, 2007, the entire contents of which are incorporated herein by reference.

### BACKGROUND

1. Field

One embodiment of the invention relates to a broadcast receiving apparatus including a receiving section for TV broadcast such as terrestrial broadcast and satellite broadcast, and a program reference chart displaying method applied to the broadcast receiving apparatus.

2. Description of the Related Art

Conventionally, various types of broadcast receiving apparatuses including receiving sections for TV broadcast such as terrestrial broadcast and satellite broadcast are in practical use. In recent years, widespread is a broadcast receiving apparatus compatible for digital broadcast which receives a broadcast wave of digital broadcast in addition to that of conventional analog broadcast and displays video of a program by using a video signal taken out from the received broadcast wave.

In a digital broadcast receiving apparatus receiving digital broadcast, by using a built-in or external disk recorder (for example, a hard disk apparatus and the like) which records data by using a disk shaped recording medium such as a hard disk, a DVD-RAM and a DVD-R, it is also possible to record video data and to reproduce video by using the recorded video data.

Conventionally, when the broadcast receiving apparatus reproduces a program by using video data recorded in the hard disk apparatus and the like, a reference chart of the recorded programs is displayed in a display apparatus prior to reproduction so that a user can select a desired program thereamong.

As for displaying of the program reference chart as above, the following video/sound reproducing apparatus is disclosed in Japanese Patent Application Publication (KOKAI) No. 2006-166303 (Patent Document 1), for example. This video/sound reproducing apparatus provides a list in which contents in a built-in recording medium and in a recording medium through a network are collectively managed so that locations where the contents exist are not required to be cared for.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing two digital broadcast receiving apparatuses according to an embodiment of the invention and an HDD as a disk recorder connected thereto;

FIG. 2 is an exemplary block diagram showing a configuration of a network system in the embodiment;

FIG. 3 is an exemplary block diagram showing a main configuration of the inside of a digital broadcast receiving apparatus in the embodiment;

FIG. 4 is an exemplary flowchart showing operating procedures of program list displaying in the embodiment;

FIG. 5 is an exemplary diagram showing an example of a program list in the embodiment;

FIG. 6 is an exemplary flowchart showing other operating procedures of program list displaying in the embodiment;

FIG. 7A and FIG. 7B are exemplary diagrams showing other examples of the program list, FIG. A showing a program list of reproducible programs and FIG. B showing a program list of irreproducible programs in the embodiment;

FIG. 8 is an exemplary flowchart showing still other operating procedures of program list displaying in the embodiment;

FIG. 9 is an exemplary diagram showing a program list different from those in FIG. 5 and FIG. 7 in the embodiment;

FIG. 10A to FIG. 10C are exemplary diagrams showing an example of data layout, FIG. 10A showing title data, FIG. 10B showing a file name list, and FIG. 10C showing metadata in the embodiment;

FIG. 11 is an exemplary diagram showing an example of program metadata in the embodiment; and

FIG. 12 is an exemplary diagram showing a partial example of the metadata in the embodiment.

### DETAILED DESCRIPTION

Various embodiments according to the invention will be described hereinafter with reference to the accompanying drawings. In general, according to one embodiment of the invention, a broadcast receiving apparatus includes: a tuner selecting and receiving a broadcast signal of digital broadcast; a recording control module making video data obtained by the tuner receiving the broadcast signal recorded in a recording medium; a video reproducing module reproducing a video signal by using the video data recorded in the recording medium; a video data selecting module selecting only identical apparatus video data obtained by the tuner of the identical apparatus receiving the broadcast signal, among the video data recorded in the recording medium; and a displaying control module making a program reference chart corresponding to the identical apparatus video data selected by the video data selecting module displayed.

Further, a program reference chart displaying method applied to a broadcast receiving apparatus has the following constitution, the broadcast receiving apparatus including a tuner selecting and receiving a broadcast signal of digital broadcast; a recording control module making video data obtained by the tuner receiving the broadcast signal recorded in a recording medium; and a video reproducing module reproducing a video signal by using the video data recorded in the recording medium. In other words, the program reference chart displaying method includes: selecting only identical apparatus video data obtained by the tuner of the identical apparatus receiving the broadcast signal, among the video data recorded in the recording medium; and making a program reference chart corresponding to the selected identical apparatus video data displayed.

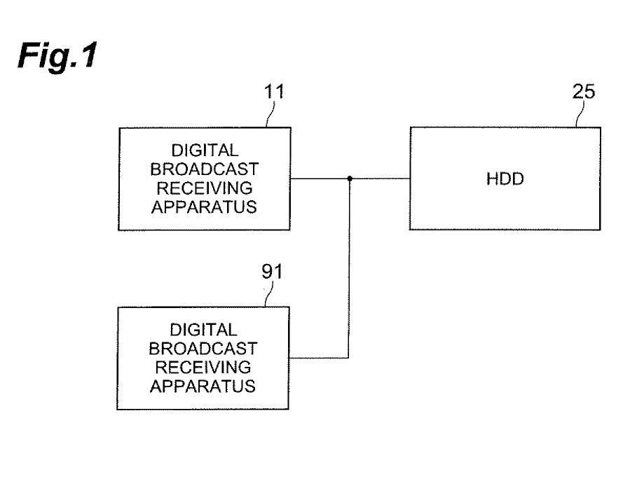

FIG. 1 is a diagram showing digital broadcast receiving apparatuses 11, 91 according to an embodiment of the invention and a hard disk apparatus (HDD: Hard Disk Drive) 25 as a disk recorder connected thereto.

When connected to the HDD 25 respectively, the digital broadcast receiving apparatuses 11, 91 record video data (later-described title data 100) obtained by each apparatus receiving a broadcast wave in a hard disk of the HDD 25 to perform recording of the programs it should be noted that since the digital broadcast receiving apparatus 91 has the same constitution as the digital broadcast receiving apparatus 11, description hereinafter will be done centering on the digital broadcast receiving apparatus 11.

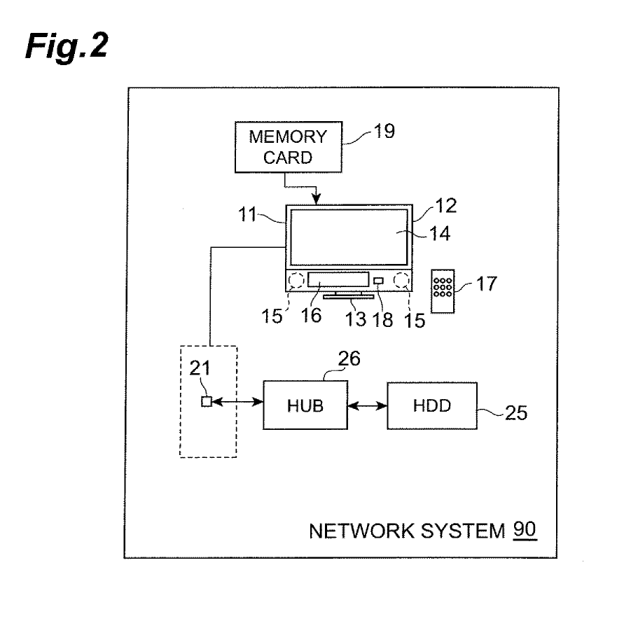

Next, FIG. 2 is a block diagram showing a configuration of the digital broadcast receiving apparatus 11 and a network system 90 configured centering on the digital broadcast receiving apparatus 11.

The digital broadcast receiving apparatus 11 includes a cabinet 12 and a support table 13 supporting the cabinet 12 with the cabinet 12 raised, as shown in FIG. 2. The cabinet 12 includes a flat panel type liquid crystal display apparatus 14 having a liquid crystal display panel, a speaker 15 as a sound output section outputting sound, and an operation part 16, and also includes a light receiving part 18 receiving operation information transmitted from a remote controller 17.

The digital broadcast receiving apparatus 11 is a video display apparatus displaying video by means of the liquid crystal display apparatus 14 as a video displaying section displaying video, and displays video by using video data obtained as a result that a later-described tuner 45 or the like receives a broadcast wave, or the video data read from the HDD 25.

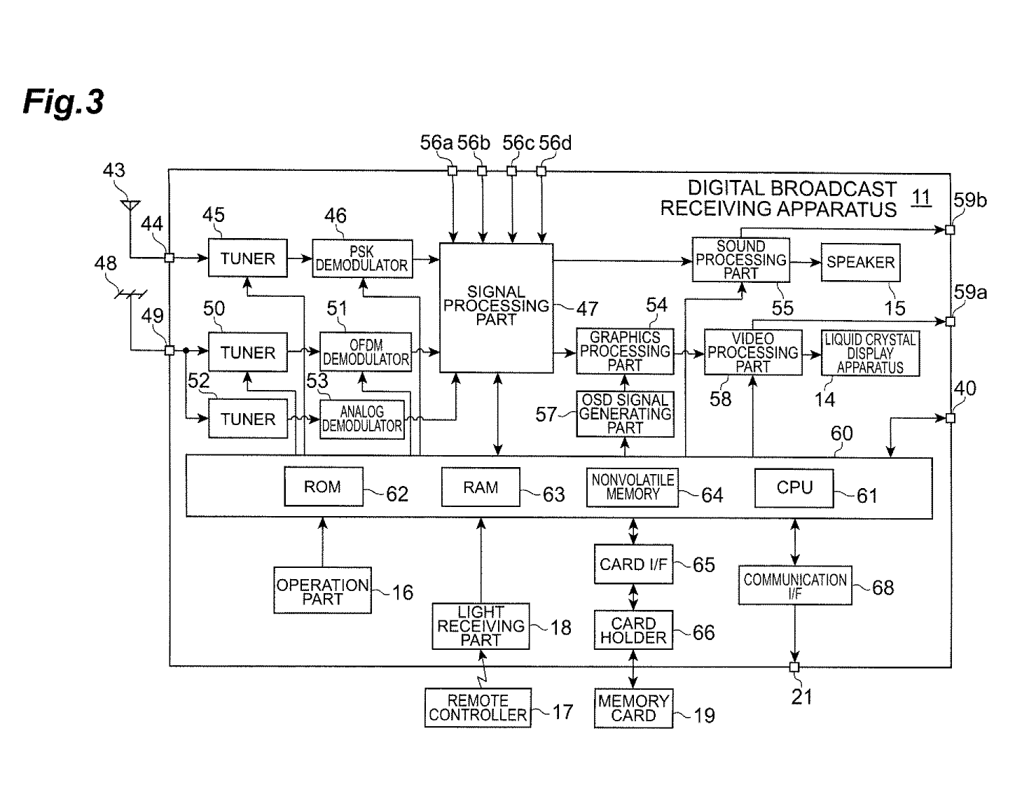

A memory card 19 (see FIG. 3) such as an SD (Secure Digital) memory card or a USE memory, for example, is attachable and detachable to and from the digital broadcast receiving apparatus 11, and recording/reproducing of a program, a photograph and the like are performed by using the memory card 19.

The digital broadcast receiving apparatus 11 includes a LAN (Local Area Network) terminal 21. The LAN terminal 21 is used as a general LAN-compatible port in which Ethernet (registered trademark) is used. The LAN-connected HDD (Network Attached Storage) 25 is connected to the LAN terminal 21 via a hub 26, for example. In addition, the digital broadcast receiving apparatus 11 includes a not-shown LAN terminal, and to the LAN terminal are connected apparatuses such as a PC (Personal Computer), a DVD (Digital Versatile Disk) recorder having a built-in HDD, so that information transmission with such apparatuses is performed.

Next, a configuration of the inside of the digital broadcast receiving apparatus 11 will be described with reference to FIG. 3. FIG. 3 is a block diagram showing a main configuration of the inside of the digital broadcast receiving apparatus 11.

The digital broadcast receiving apparatus 11 includes input terminals 44, 49, tuners 45, 50, 52, and a PSK (Phase Shift Keying) demodulator 46. The digital broadcast receiving apparatus 11 also includes a signal processing part 47, an OFDM (Orthogonal Frequency Division Multiplexing) demodulator 51, an analog demodulator 53, a graphics processing part 54, a sound processing part 55, an OSD signal generating part 57 and a video processing part 58.

A satellite digital broadcast signal received by a BS/CS digital broadcast receiving antenna 43 is inputted to the input terminal 44. The satellite digital broadcast signal is supplied to the tuner 45 from the input terminal 44. The tuner 45 is a tuner for satellite digital broadcast, and selects and receives a broadcast signal of a desired channel from the satellite digital broadcast signals supplied thereto.

The broadcast signal which is selected by the tuner 45 is supplied to the PSK demodulator 46. The PSK demodulator 46 performs a demodulation processing of digital video signal and sound signal, and outputs the digital video signal and sound signal to the signal processing part 47.

A terrestrial digital broadcast signal received by a terrestrial broadcast receiving antenna 48 is inputted to the input terminal 49. The terrestrial digital broadcast signal is supplied to the tuner 50 from the input terminal 49. The tuner 50 is a tuner for terrestrial digital broadcast, and selects and receives a broadcast signal of a desired channel from the terrestrial digital broadcast signals supplied thereto.

The broadcast signal selected by the tuner 50 is supplied to the OFDM demodulator 51. The OFDM demodulator 51 performs a demodulation processing of digital video signal and sound signal, and outputs the digital video signal and sound signal to the signal processing part 47.

A terrestrial analogue broadcast signal received by the terrestrial broadcast receiving antenna 48 is also inputted to the input terminal 49. The terrestrial analogue broadcast signal is supplied to the tuner 52 from the input terminal 49. The tuner 52 is a tuner for terrestrial analogue broadcast, and selects and receives a broadcast signal of a desired channel from the terrestrial analogue broadcast signals supplied thereto.

The broadcast signal selected by the tuner 52 is supplied to the analogue demodulator 53. The analogue demodulator 53 performs a demodulation processing of analogue video signal and sound signal, and outputs the analogue video signal and sound signal to the signal processing part 47.

The signal processing part 47 selectively applies a predetermined digital signal processing to the digital video signal and sound signal supplied respectively from the PSK demodulator 46 and the OFDM demodulator 51, and outputs the digital video signal and sound signal to the graphics processing part 54 and the sound processing part 55.

A plurality (four in the case of the illustration) of input terminals 56a, 56b, 56c, 56d are connected to the signal processing part 47. These input terminals 56a to 56d enable inputting of analogue video signals and sound signals from a not-shown DVD recorder and the like as an external apparatus.

This signal processing part 47 selectively digitizes the analogue video signals and sound signals supplied respectively from the analogue demodulator 53 and the respective input terminals 56a to 56d. The signal processing part 47 applies predetermined digital signal processings on the digitized video signals and sound signals, and thereafter, outputs the digitized video signals and sound signals to the graphics processing part 54 and the sound processing part 55.

The graphics processing part 54 superimposes an OSD (On Screen Display) signal generated in the OSD signal generating part 57 on the digital video signal supplied from the signal processing part 47, and outputs the superimposed signal. The graphics processing part 54 can selectively output the output video signal of the signal processing part 47 and the OSD signal outputted by the OSD signal generating part 57, and also can combine and output both the outputs so that both the outputs constitute halves of the screen respectively.

The digital video signal outputted from the graphics processing part 54 is supplied to the video processing part 58. The video processing part 58 converts the inputted digital video signal to a video signal in a format displayable in the liquid crystal display apparatus 14, and thereafter, outputs the video signal to the liquid crystal display apparatus 14. The liquid crystal display apparatus 14 displays video by using the video signal. The video signal is reproduced by those signal processing part 47, graphics processing part 54 and video processing part 58, and those constitute a video reproducing module. The video processing part 58 leads the analogue video signal to the outside through an output terminal 59a.

The sound processing part 55 converts the inputted digital sound signal to an analogue sound signal in a format reproducible in the speaker 15, and thereafter, outputs the analogue sound signal to the speaker 15. The sound processing part 55 also leads the analogue sound signal to the outside through an output terminal 59b.

The digital broadcast receiving apparatus 11 includes a control part 60, a card holder 66 and various kinds of interfaces (card I/F 65, communication I/F 68).

The control part 60 includes a CPU (Central Processing Unit) 61, a ROM (Read Only Memory) 62, a RAM (Random Access Memory) 63 and a nonvolatile memory 64. The control part 60 comprehensively controls the operations of the digital broadcast receiving apparatus 11 including an operation of receiving the broadcast signal. The control part 60 receives operation information from the operation part 16, or receives operation information sent out from the remote controller 17 through the light receiving part 18, and controls each part so that an operation content thereof is reflected.

While the CPU 61 operates as various kinds of modules (recording control module, displaying control module, video data selecting module) in accordance with programming stored in the ROM 62, the CPU 61 performs input/output of the signal from and to other components to perform operation control of the entire digital broadcast receiving apparatus 11.

For example, the CPU 61 performs an operation as the recording control module outputting the video data to the HDD 25 through the communication I/F 68 and making the video data recorded in the HDD 25. The CPU 61 also performs an operation as a reproducing control module reading the recorded video data from the HDD 25 and instructing the signal processing part 47, the graphics processing part 54, the video processing part 58 and the like to reproduce the video.

The ROM 62 mainly stores control programming to be executed by the CPU 61. The RAN 63 provides a work area to the CPU 61. The nonvolatile memory 64 stores various types of setting information, control information and the like.

The control part 60 is connected through the card I/F (Interface) 65 to the card holder 66 to which the memory card 19 is attachable. Thereby, the control part 60 can perform information transmission through the memory card 19 attached to the card holder 66, and the card I/F 65.

The control part 60 is also connected to the LAN terminal 21 through the communication I/F 68. Thereby, the control part 60 can perform information transmission with each apparatus connected to the LAN terminal 21, such as the HDD 25, through the communication I/F 68.

### Description of Operation Content

Next, an operation content of program list displaying performed by the digital broadcast receiving apparatus 11 with the above configuration will be described. In the embodiment, the program list displaying means an operation to make the liquid crystal display apparatus 14 display a reference chart of programs to be reproduced by using the video data recorded in the HDD 25.

Both of the digital broadcast receiving apparatuses 11, 91 are connected to the HDD 25, and the title data 100, a file name list 120, and program metadata 140 are recorded in the HDD 25 (the title data 100, the file name list 120 and the program metadata 140 will be described later). Details will be described later.

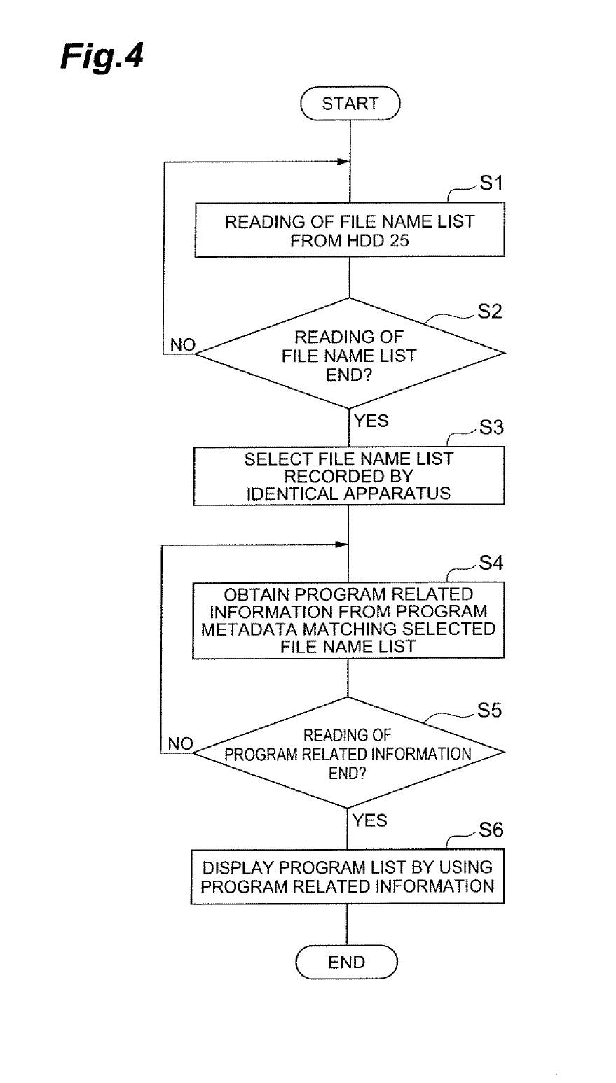

The digital broadcast receiving apparatus 11 performs the program list displaying in accordance with a flowchart shown in FIG. 4. In this case, when a user performs a displaying request of the program list by using the remote controller 17, the digital broadcast receiving apparatus 11 performs the program list displaying in accordance with the flowchart shown in FIG. 4. The program list displaying is controlled by the CPU 61 in accordance with the flowchart shown in FIG. 4.

When detecting that the displaying request of the program list is performed, the CPU 61 starts the program list displaying and performs reading of the recorded file name list 120 from the HUD 25 (block S1).

Next, the CPU 61 proceeds the operation to a block S2 and Judges whether or not reading of the file name list 120 from the HDD 25 ends (whether or not all of the file name list is read). Here, if the reading ends, the CPU 61 proceeds the operation to a block S3, and otherwise, the CPU 61 returns to the block S1 to perform the reading of the file name list 120.

Subsequently, the CPU 61 proceeds the operation to the block S3 to perform an operation as a video data selecting module, and in order to select only identical apparatus video data obtained by receiving the broadcast signal by the tuners 45, 50 of the identical apparatus and recording it, selects a file name list 120 (later-described file name list 121) corresponding to video data recorded by the identical apparatus, among the file name list 120 read in the block S1.

9 In a subsequent block S4, the CPU 61 obtains program related information (information such as recording date and recording time) from program metadata 140 (later-described program metadata 141) matching the selected file name list 121. Further, in a block S5, the CPU 61 judges whether or not reading of the program related information ends, and if the reading of the program related information has ended the CPU 61 proceeds the operation to a block S6, and otherwise, the CPU 61 returns to the block S4.

Then, proceeding the operation to the block S6, the CPU 61 performs an operation as a displaying control module and makes the liquid crystal display apparatus 14 display a later-described program list 200 by using the file name list 121 selected in the block S3 and the program related information obtained in the block S4, and thereafter, the CPU 61 terminates the program list displaying.

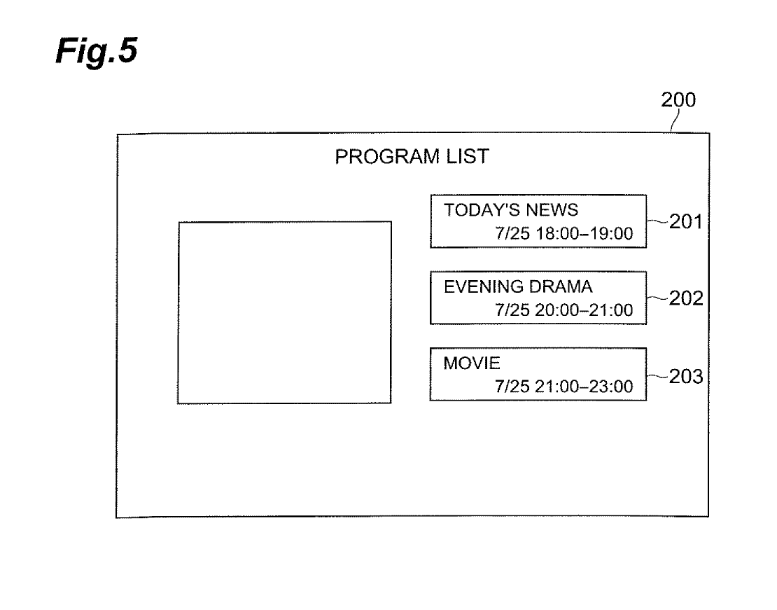

When the program list displaying is performed as above, the program list 200 is displayed in the liquid crystal display apparatus 14 as shown in FIG. 5. In this program list 200 are displayed the file name list 121 selected in the block S3 and title items 201, 202, 203 of programs corresponding to the program related information obtained in the block S5. An abbreviated name or date/time of the recorded program is included the respective title items 201, 202, 203.

In the digital broadcast receiving apparatus 11, when the program list displaying is performed as above, only the identical apparatus video data obtained by receiving the broadcast signal by the identical apparatus is selected to display the program list 200, and therefore each of the title items 201, 202, 203 corresponds to the identical apparatus video data.

Accordingly, a user who sees the program list 200 does not wonder whether the title items 201, 202, 203 are irreproducible programs or reproducible programs, respectively. Further, when the program to be reproduced is selected from the program list 200, every program is reproducible, and so the user does not have to perform an additional operation such as selecting the program again, so that convenience for the user can be enhanced at a time that the user tries to reproduce the recorded program.

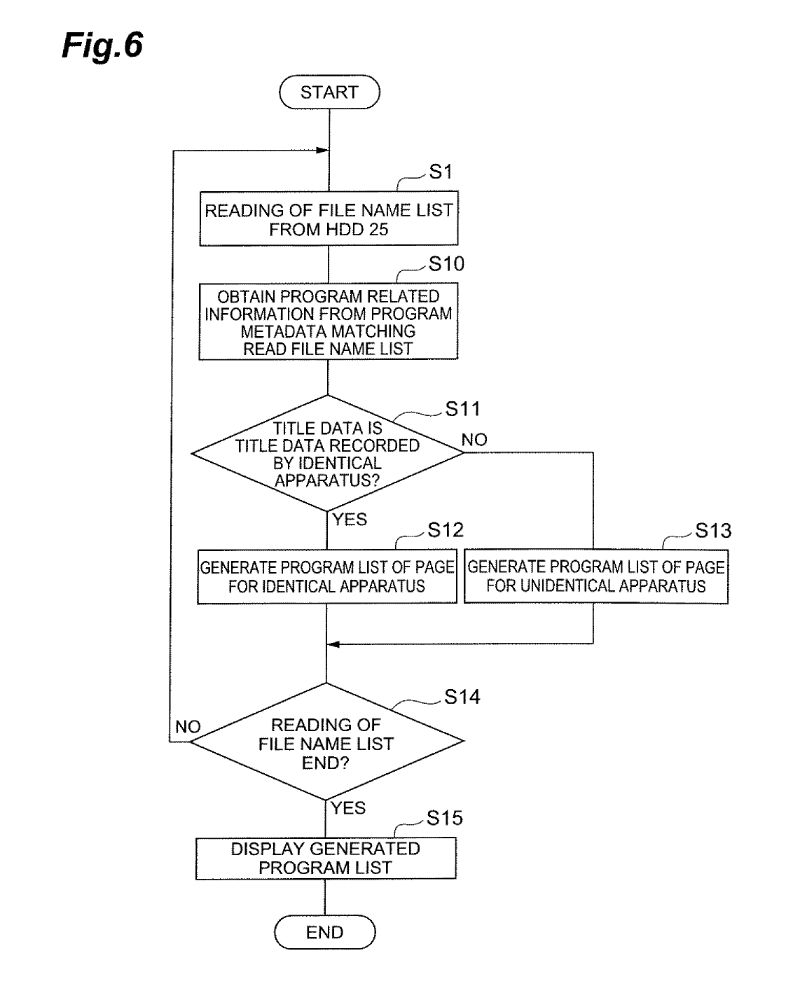

Program list displaying can be performed by a CPU 61 also according to a flowchart shown in FIG. 6.

In other words, the CPU 61 performs a block S1 similarly to in a case of FIG. 4 and thereafter proceeds the operation to a block S10 to obtain program related information from program metadata 140 which matches a read file name list 120.

Subsequently, the CPU 61 proceeds the operation to a block S11 to perform an operation as a judging module and judges, in accordance with the read file name list 120, whether or not title data 100 corresponding thereto is identical apparatus video data. If the CPU 61 judges that the title data 100 is the identical apparatus video data, the CPU 61 proceeds the operation to a block S12, and otherwise, the CPU 61 proceeds the operation to a block S13.

When proceeding the operation to the block S12 the CPU 61 performs an operation as a list generating module and generates a program list of a page for an identical apparatus by using the read file name list 120 and the program related information obtained in the block S10. Further, also in the block S13, the CPU 61 performs the operation as the list generating module and generates a program list of a page for an unidentical apparatus by using the file name list 120 and the program related information obtained in the block S10.

Further, in a block S14, the CPU 61 judges whether or not reading of the file name list 120 of an HDD 25 ends. Here, if the reading ends, the CPU 61 proceeds to a block S15, and otherwise, the CPU 61 returns to the block S1 and performs the reading of the file name list 120.

When proceeding the operation to the block s15, the CPU 61 performs an operation as a displaying control module and makes a liquid crystal display apparatus 14 display the program list of the page for the identical apparatus and/or the program list of the page for another apparatus which are generated in the blocks S12, S13, and thereafter terminates the program list displaying.

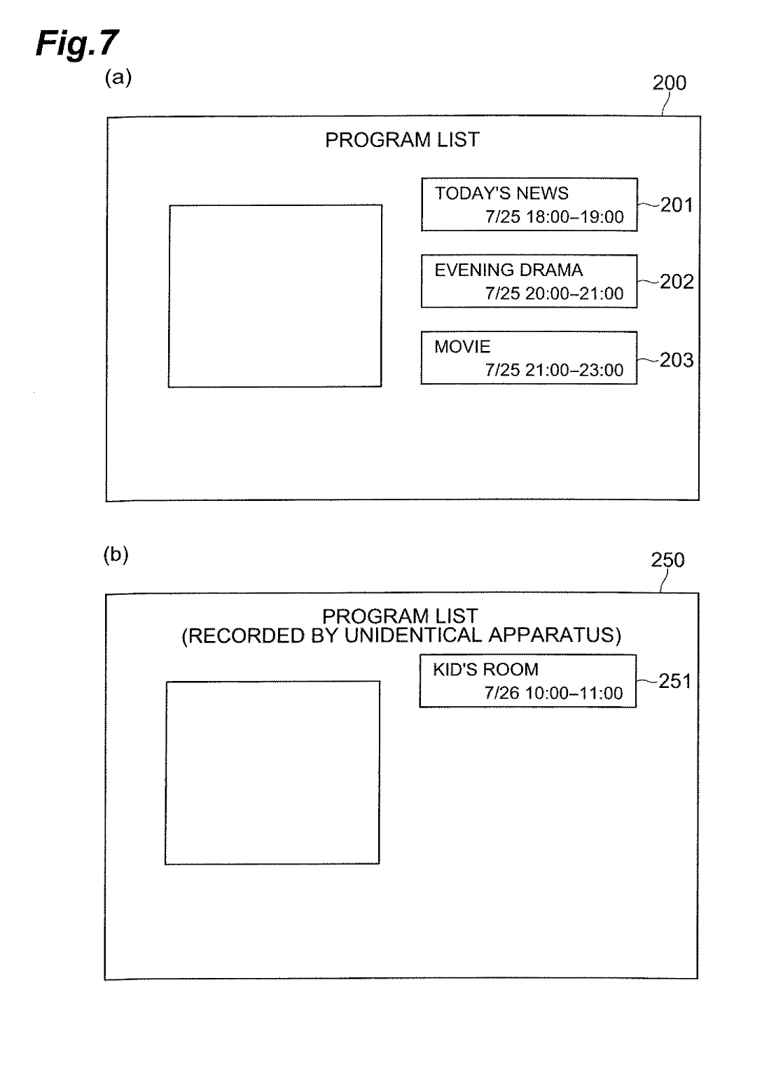

When the program list displaying is performed as above, a program list 200 shown in FIG. 7A, which is similar to the above-described list, is displayed as the program list of the page for the identical apparatus, and a program list 250 shown in FIG. 7B is displayed as the program list of the page for the unidentical apparatus, in the liquid crystal display apparatus 14.

In the program list 200 are displayed only title items 201, 202, 203 of the program corresponding to the identical apparatus video data similarly to in the above-described case, while in the program list 250 is displayed a title item 251 of the program corresponding to the title data other than the identical apparatus video data.

As described above, in the digital broadcast receiving apparatus 11, the file name list 120 is classified into the file name list 121 corresponding to the identical apparatus video data and the file name list 122 corresponding other than such data, and the program list 200 and the program list 250 which respectively correspond thereto are displayed with being clearly classified into different pages. In the program list 250, it is displayed as “program list (recorded by another apparatus)”, clarifying that the program is recorded by an apparatus different from the identical apparatus.

Therefore, a user seeing the program lists 200, 250 does not wonder whether the title items 201, 202, 203, 251 are irreproducible programs or reproducible programs. Since every program is reproducible when the user selects a program desired to be reproduced from the program list 200, the user does not have to perform an additional operation, so that convenience for the user can be enhanced at a time that the user tries to reproduce the recorded program.

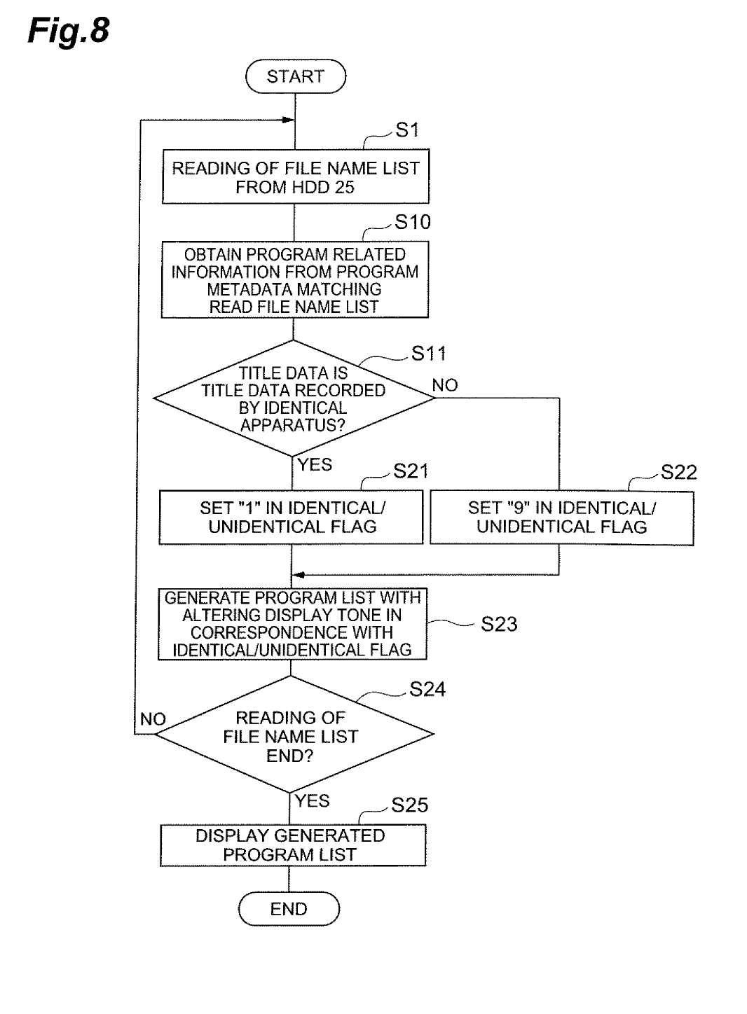

Further, program list displaying can be performed by a CPU 61 also in accordance with a flowchart shown in FIG. 8.

In other words, similarly to in a case of FIG. 6, after performing blocks S1, S10, the CPU 61 proceeds the operation to a block S11 to perform an operation as a judging module. In this case, the CPU 61 judges, in accordance with a read file name list 120, whether or not title data 100 corresponding thereto is identical apparatus video data. If the CPU 61 judges that the title data 100 is the identical apparatus video data, the CPU 61 proceeds the operation to a block S21, and otherwise, the CPU 61 proceeds the operation to a block S22.

When proceeding the operation to the block S21, the CPU 61 sets data (for example, “1”) indicating being the identical apparatus in an identical/unidentical flag indicating whether the apparatus is the identical apparatus or unidentical apparatus. When proceeding the operation to the block S22, the CPU 61 sets data (for example, “9”) indicating being an unidentical apparatus in the identical/unidentical flag.

Next, the CPU 61 proceeds the operation to a block S23 to perform an operation as a list generating module, and, alternating a display tone in correspondence with the identical/unidentical flag, generates a later-described program list 300. In this case, the respective title items are generated in a normal tone when the identical/unidentical flag indicates “1”, while the respective title items are generated in a lower tone when the identical/unidentical flag indicates “9”.

Subsequently, the CPU 61 performs a block S24 similarly to in the block S14 in the case of FIG. 6. When reading of the file name list 120 ends, the CUP 61 proceeds to a block S25, and otherwise, the CPU 61 returns to the block S1 to perform the reading of the file name list 120.

When proceeding the operation to the block S25, the CPU 61 performs an operation as a displaying control module and makes a liquid crystal display apparatus 14 display the program list 300 generated in the block S23, and thereafter terminates program list displaying.

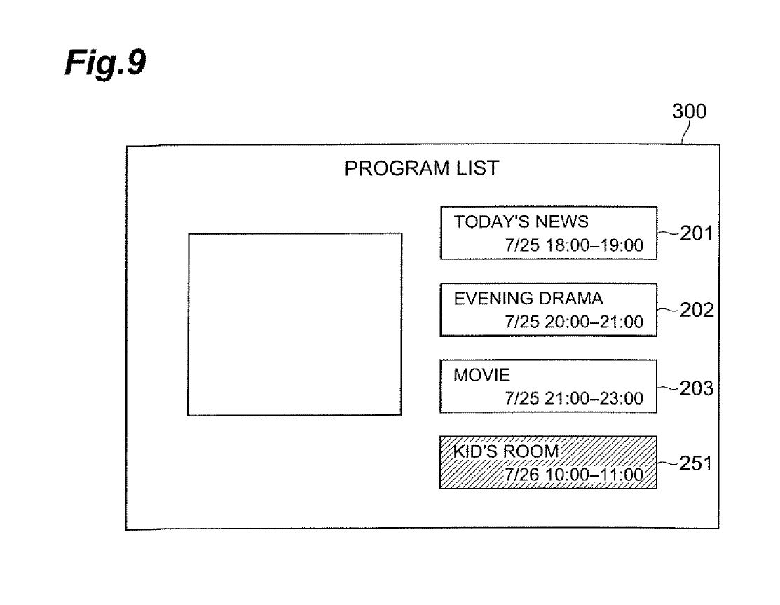

As a result, the program list 300 is displayed in the liquid crystal display apparatus 14, as shown in FIG. 9, for example. In the program list 300, there are displayed title items 201, 202, 203 corresponding to identical apparatus video data, and also a title item 251 corresponding to a title data other than the identical apparatus video data.

However, the title item 251 is displayed in a lower display tone than a tone in which the title items 201, 202, 203 are displayed. In FIG. 9, the title item 251 is hatched instead.

A user seeing the program list 300 as above can clearly distinguish the title items 201, 202, 203 from the title item 251 by means of difference in the display tones, so that the user does not wonder whether the respective title items 201, 202, 203, 251 are irreproducible programs or reproducible programs.

When the user selects a program desired to be reproduced from the title items 201, 202, 203, each program is reproducible and the user does not have to perform an additional operation. Thus, convenience for the user can be enhanced at a time that the user tries to reproduce the recorded program.

It should be noted that though in the block S23, the CPU 61 generates the program list 300 with altering the display tone in correspondence with the identical/unidentical flag, it is possible to alter a display color instead of altering the display tone. Further, it is also possible to display a signal (for example, * *) indicating being an unidentical apparatus in the title item only in a case that the identical/unidentical flag indicates “9”.

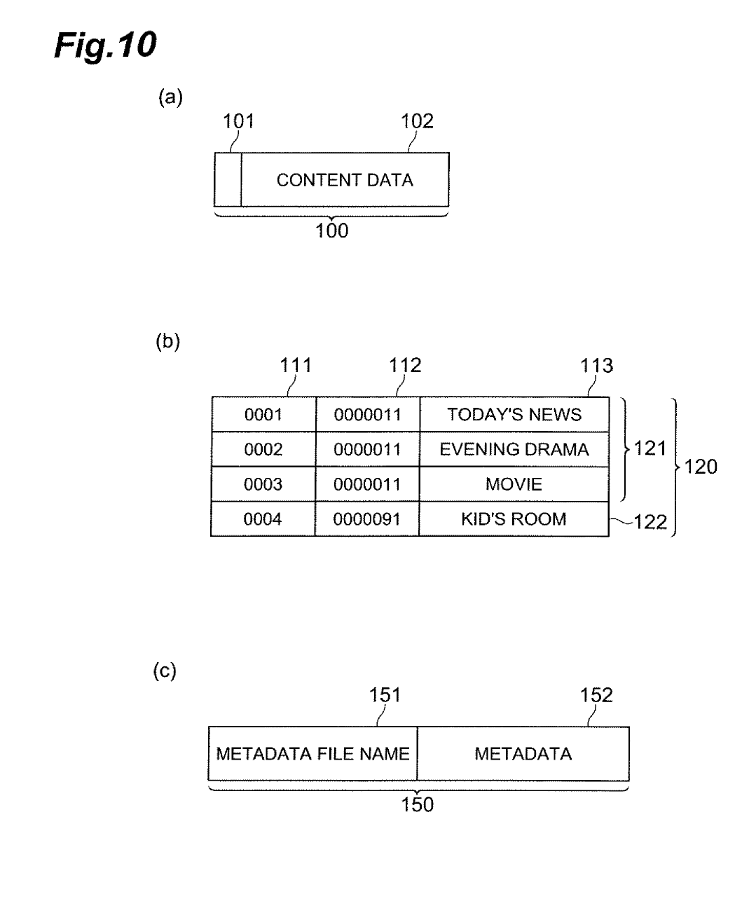

As shown in FIG. 10A, the title data 100 has a content code 101 and content data 102 to reproduce video and is constituted as a file per recorded program.

In the content code 101, there is recorded code information to specify the content data 102.

The file name list 120 is generated to correspond to the title data 100, and as shown in FIG. 10B, has a content code 111, an apparatus ID 112, and a file name 113.

In FIG. 10B, as the file name list 120, there are shown three pieces in a file name list 121 with an apparatus ID 112 of “0000011” and one piece in a file name list 122 with an apparatus ID 112 of “0000091”, that is, four pieces in total are shown.

In the apparatus ID 112 is recorded an identification code of a broadcast receiving apparatus having received the recorded program while in the file name 113 is recorded a program name of the title data 100 corresponding thereto.

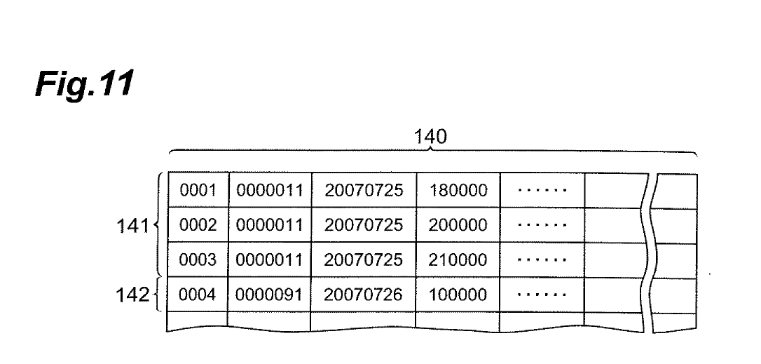

In FIG. 11, the program metadata 140 is shown. The program metadata 140 has the identification code and the apparatus ID, as well as program related information such as a recording date and recording time, and the like.

In FIG. 11, four pieces of program metadata 140 are shown. Three pieces of program metadata 141 among these are data obtained by the digital broadcast receiving apparatus 11 receiving a program and one piece of program metadata 142 is data obtained by the digital broadcast receiving apparatus 91 receiving a program.

In the program metadata 141, “0000011” indicating being the digital broadcast receiving apparatus 11 is set in the apparatus ID, while in the program metadata 142, “0000091” indicating being the digital broadcast receiving apparatus 91 is set in the apparatus ID.

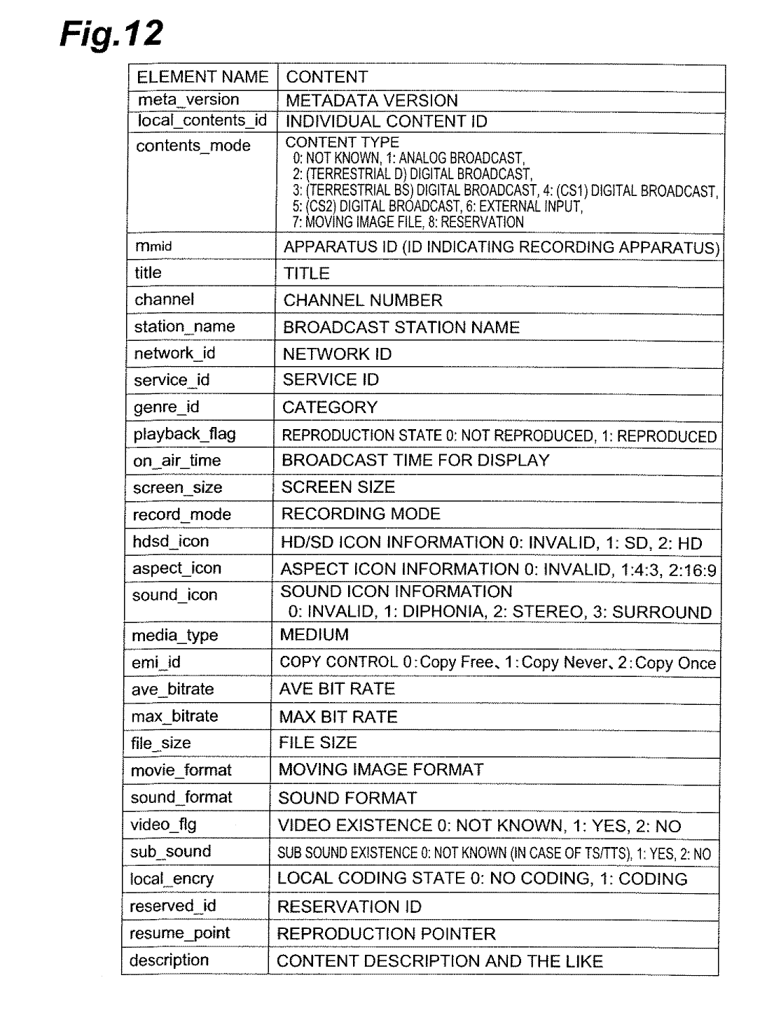

The title data 100 can have a constitution with metadata 150 as adjunct data shown in FIG. 100. The metadata 150 has a metadata file name 151 and metadata 152. In the metadata file name 151 are stored almost the same data as the program metadata 140, while in the metadata 152 are included data (for example, individual content ID, an apparatus ID, a channel number and the like) of a plurality of items shown in FIG. 12.

As described above, the digital broadcast receiving apparatus 11 performs the operation as the recording control module when the title data 100 is recorded in the HOD 25, and records in the file name list 120 the apparatus ID 112 as the identification code identifying whether the tuner of the identical apparatus has received the broadcast signal or the tuner of the unidentical apparatus has received the broadcast signal.

Thus, when performing the block 83, the CPU 61, referring to the apparatus ID 112 in the file name list 120, can select only the file name list 121 whose apparatus ID 112 is “0000011”.

Then, only the file name list 121 is selected in which the digital broadcast receiving apparatus having received the program is the digital broadcast receiving apparatus 11. Accordingly, with reference to the content code 111 of the selected file name list 121, it is possible to select only the title data 100 whose program has been received by the identical apparatus and whose video is reproducible.

When performing the block S11, it is possible that the CPU 61 similarly refers to the apparatus ID 112 and if the apparatus ID 112 is “0000011”, the CPU 61 proceeds the operation to the block 512, while if the apparatus ID 112 is “0000091”, the CPU 61 proceeds the operation to the block S13.

Further, in either case of the block S3 and the block S11, even when the metadata file name 151 is referred to, the operation can be performed similarly to in the above.

The digital broadcast receiving apparatus 11 can once reproduce the title data 100 to check whether or not the title data 100 is reproducible, and then set reproduction allowability data indicating a result thereof in the metadata file name 151. Thus, the reproduction allowability data can be used at a time of judgment in the block S10.

It should be noted that the digital broadcast receiving apparatus 11 can also use the apparatus ID recorded in the metadata file name 151 at a recording time, in order to judge whether or not the title data is the one that has been recorded by the identical apparatus.

The above-described embodiment is described with the digital broadcast receiving apparatus 11 as a television receiving apparatus having the liquid crystal display apparatus 14 being taken as an example of the broadcast receiving apparatus. However, the embodiment can be applied to a broadcast apparatus having a tuner such as a DVD player and a DVD recorder and capable of performing recording or reproduction of video data.

Further, though a case that the HDD is connected as the disk recorder to the digital broadcast receiving apparatus 11 is exemplified, the invention can also be applied to a case that a disk recorder using an optical disk such as a DVD-R and a DVD-RAM is connected.

Though the hard disk included in the HDD as the disk recorder is exemplified as the recording medium, the embodiment can be applied to a case that recording is performed by using a recording medium such as an SD memory card.

The description in the above is to describe the embodiments of the invention and, in no case, limits the apparatus and method of the invention, so that various modifications can be embodied with ease. Further, the device and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiving apparatus comprising:
a tuner selecting and receiving a broadcast signal of digital broadcast;
a recording control module making video data obtained by said tuner receiving the broadcast signal recorded in a recording medium;
a video reproducing module reproducing a video signal by using the video data recorded in the recording medium;
a video data selecting module selecting only identical apparatus video data obtained by said tuner of the identical apparatus receiving the broadcast signal, among the video data recorded in the recording medium; and
a displaying control module making a program reference chart corresponding to the identical apparatus video data selected by said video data selecting module displayed.

2. A broadcast receiving apparatus comprising:
a tuner selecting and receiving a broadcast signal of digital broadcast;
a recording control module making video data obtained by said tuner receiving the broadcast signal recorded in a recording medium;
a video reproducing module reproducing a video signal by using the video data recorded in the recording medium; and
a displaying control module making a program reference chart corresponding to the video data recorded in the recording medium displayed, with separately classifying a program item corresponding to identical apparatus video data obtained by said tuner of the identical apparatus receiving the broadcast signal and a program item corresponding to unidentical apparatus video data other than the identical apparatus video data.

3. The broadcast receiving apparatus according to claim 1, wherein
said recording control module makes the video data recorded in the recording medium, with including an identification code to identify whether said tuner of the identical apparatus has received the broadcast signal or said tuner of an unidentical apparatus has received the broadcast signal.

4. The broadcast receiving apparatus according to claim 1, wherein
said video data selecting module selects only the identical apparatus video data in accordance with adjunct data accompanying the video data.

5. The broadcast receiving apparatus according to claim 1, wherein
said video reproducing module has a video displaying section displaying video by using the video data obtained by said tuner receiving the broadcast wave.

6. A program reference chart displaying method applied to a broadcast receiving apparatus comprising a tuner selecting and receiving a broadcast signal of digital broadcast; a recording control module making video data obtained by said tuner receiving the broadcast signal recorded in a recording medium; and a video reproducing module reproducing a video signal by using the video data recorded in the recording medium, the program reference chart displaying method comprising:
selecting only identical apparatus video data obtained by said tuner of the identical apparatus receiving the broadcast signal, among the video data recorded in the recording medium; and
making a program reference chart corresponding to the selected identical apparatus video data displayed.
